(19) United States
(12) Patent Application Publication
(10) Pub. No.: US 2007/0091377 A1
(43) Pub. Date: Apr. 26, 2007

(54) Real-time auditing of covert data marks

(76) Inventor: Patrick Smith, Norwalk, CT (US)

Correspondence Address: James G. Coplit, Esq.;GRIMES & BATTERSBY, LLP, Third Floor, 488 Main Avenue, Norwalk, CT, 06851, US

(21) Appl. No.: 11/435,604

(22) Filed: May 17, 2006

Related U.S. Application Data
(60) Provisional application No. 60/682,104, filed on May 18, 2005.

(51) Int. Cl. H04N 1/40; G06K 9/00

(52) U.S. Cl. 358/3.28; 382/100

(57) ABSTRACT

A system and method is provided for the real time auditing of covert data marks. Specific information relating to a product or document is entered into an information cell or shell from a product data file. A high definition, high resolution, high speed inline video system is provided to take specific details from the individual product or document, which details are added to the data cell or shell. Details are then inspected, quality checked, matched in the event there are multiple identifiers (e.g., currency would normally carry two matching sequential numbers), and verified to the product order. This cell or shell is passed to the special design computer/controller through a high speed electronic interface. Information entering the computer/controller is once again verified and matched to the original data as well as the product or document. The cell or shell is converted into a specially created 2-dimensional bar code which is encrypted by the computer/controller and then transformed into a video rip. This video rip is sent to high quality/high resolution production print engines. The encrypted 2-dimensional bar code is imaged directly to the product or document as it is carried past the print imaging engines. The ink also is specially designed and manufactured for this system and process. It is an invisible ink which is unique, durable, permanent and not available commercially (covered under trade secrets). These special inks are well suited for delivery using inkjet technology to efficiently make well formed invisible images at slow to high speed production schemes. The product or document is then sent instantly into a drying scheme (this can be air, forced air, heat, UV Dryer, depending on the printing system selected). After drying there is a final scanning. This scanning equipment is the same scanner design which will be used in the field so that each product or document will be verified with the actual scanning device and programs which will be used in the field. From this final scanning of the 2-dimensional data bar code, a final audited product or document profile is created, as is a database which will be the point of reference in the infrastructure during the life of the product or document. Each time any product or document is scanned at a transaction point, the database will be updated, either in real-time or downloaded from a data collection scanning device. This will build a complete history from the point of manufacture to the moment it is removed from service.

### RELATED APPLICATIONS

This is a non-provisional patent application claiming benefit of priority of provisional Patent Application Serial No. 60/682,104 filed on May 18, 2005 in the name of Patrick Smith for “Real-Time Auditing of Covert Marks.”

### BACKGROUND OF THE INVENTION

1. Field of the Invention

The present invention relates generally to a system and method for printing data matrix information marks on items for unique and independent identification and, more particularly, to such a system and method that can print both covert (invisible) and overt (visible) marks that may be used for a variety of purposes, including the creation of an accountability record. The system and method is designed to authenticate the individual items bearing the mark(s) as well as to verify and validate the information contained therein.

Covert, or invisible, data marks are unique, similar to a fingerprint contain information which a specifically designed barcode type scanner can decode and collect data therefrom. Such data may then be validated, verified and authenticated. The concept is to provide undetectable individual and independent identifying data marks onto high value items such as currency, traveler's checks, money orders, apparel, pharmaceutical products and packaging, coupons, checks, payment cards, lottery tickets or any other item that is the frequent target of counterfeiting, grey marketing, fraud and theft (including identity theft). Among the types of documents and products the CSSI covert solutions are meant to protect against are the following:

Counterfeit identity documents used for illegal entry into the U.S. (passports, VISA's, driver licenses, national identification cards, vehicle registrations, government of corporate identity cards, payment cards).

Fraudulent and counterfeit financial documents (checks, securities, currency, money orders, airline tickets)

Counterfeit, grey market, knockoff and pirated products of value such as pharmaceuticals, apparels, software, and fine jewelry.

It should be appreciated that covert (invisible) marking is not redundant. It is a unique identification system for each valued item. The discreet encoded invisible mark is indelibly applied to the product using an invisible medium. The product identification number (serial number as well as other important data) and the individual details are applied with an encrypted mark placed on that item, which information is also stored in a computerized database. Non-contract optical scanners are used to detect the mark and to electronically reference the database of serial numbers and product identification numbers to ensure authenticity.

Additional information may also be stored within this unique data mark, including information not typically stored using other more conventional methods (magnetic stripes, bar code, OCR, etc.). The invisible 2-dimensional encrypted bar code can be adopted for the security of identity cards so as to prevent or reduce identity theft. There exists the capability to store biometric details or information such as signatures, .jpg photos, invisible digital photos, facial biometrics, iris scans, finger as well as hand prints, etc.

2. Description of the Prior Art

Bar codes, serial numbers and other identifying indicia have long been incorporated on products and documents in an attempt to prevent fraud, counterfeiting, or tampering of the products or documents, as well as to audit or track such products or documents. Unfortunately, such indicia, being visible are therefore subject to reproduction or modification by third parties. Furthermore, during the packaging or marking process for these products and documents, there is usually a single scan of the item—usually prior to the marking of the item—which allows for inconsistency or error during the packaging process. There is a need for a process in which the item is initially scanned and then finally scanned at the conclusion of the packaging process so as to ensure the accuracy of the information thereon and to create an audit record for the products or documents.

Over the last several decades a domestic and global security crisis has been developing. Incredibly large losses are suffered at the hands of people and organizations engaging in illegal and corrupt practices which principally involve compromising the integrity of legitimate products and documents or providing counterfeit products and documents. There is a continuing practice by these people and organized groups to extract illegal profits against all kinds of legitimate individuals, commercial organizations or Governments and their agencies. Annual losses from such counterfeiting are in the billions of dollars every year, and the profits received from these practices often help finance a wide range of criminal activities and terrorism.

As will be appreciated, none of these prior patents even address the problem faced by applicant let alone offer the solutions proposed herein

### SUMMARY OF THE INVENTION

Against the foregoing background, it is a primary object of the present invention to provide a unique ink printing system designed create a complex data file while inspecting, electronically verifying, matching, printing, scanning and building directly to the products and/or documents.

It is another object of the present invention to provide such a unique ink printing system that is used for tracking and tracing either products or documents through all transaction points during the life of the individual and independent product or document.

It is yet another object of the present invention to provide such a unique ink printing system that can print both covert (invisible) and overt (visible) marks that may be used for a variety of purposes, including the creation of an accountability record.

It is still another object of the present invention to provide such a unique ink printing system that can authenticate the individual items bearing the mark(s) as well as to verify and validate the information contained therein.

It is another object of the present invention to provide such a unique ink printing system that provides undetectable individual and independent identifying data marks onto high value items and documents.

It is still yet another object of the present invention to provide such a unique ink printing system in which additional information may be stored within this unique data mark, including information not typically stored using other more conventional methods.

It is another object of the present invention to provide such a unique ink printing system in which the invisible 2-dimensional encrypted bar code can be adopted for the security of identity cards so as to prevent or reduce identity theft.

To the accomplishments of the foregoing objects and advantages, the present invention, in brief summary, comprises a system and method for the real time auditing of covert (invisible) data marks. Specific information relating to a product or document is entered into an information cell or shell from a product data file. A high definition, high resolution, high speed inline video system 18 is provided to take specific details from the individual product or document, which details are added to the data cell or shell. Details are then inspected, quality checked, matched in the event there are multiple identifiers (e.g., currency would normally carry two matching sequential numbers), and verified to the product order. This cell or shell is passed to the special design computer/controller through a high speed electronic interface.

Information entering the computer/controller is once again verified and matched to the original data as well as the product or document. The cell or shell is converted into a specially created 2-dimensional bar code which is encrypted by the computer/controller and then transformed into a video rip. This video rip is sent to high quality/high resolution production print engines. The encrypted 2-dimensional bar code is imaged directly to the product or document as it is carried past the print imaging engines. The ink also is specially designed and manufactured for this system and process. It is an invisible ink which is unique, durable, permanent and not available commercially (covered under trade secrets). These special inks are well suited for delivery using inkjet technology to efficiently make well formed invisible images at slow to high speed production schemes. The product or document is then sent instantly into a drying scheme (this can be air, forced air, heat, UV Dryer, depending on the printing system selected).

After drying there is a final scanning. This scanning equipment is the same scanner design which will be used in the field so that each product or document will be verified with the actual scanning device and programs which will be used in the field. From this final scanning of the 2-dimensional data bar code, a final audited product or document profile is created, as is a database which will be the point of reference in the infrastructure during the life of the product or document. Each time any product or document is scanned at a transaction point, the database will be updated, either in real-time or downloaded from a data collection scanning device. This will build a complete history from the point of manufacture to the moment it is removed from service.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a flow chart illustrating the various components of the system and method for the real time auditing of covert data marks of the present invention;

FIG. 2 is a diagram illustrating the capture, print and verification processes of the system and method of FIG. 1;

FIG. 3 is a side elevational view of the transport system and components of the system and method of FIG. 1;

FIG. 3A is a front perspective view of an alternative transport system and components for the system and method of FIG. 1;

FIG. 4A is a front perspective view of a flat roll paper transport system for the system and method of FIG. 1;

FIG. 4B is a cut-away, side elevational view of the flat roll paper transport system of FIG. 4A; and

FIG. 5A and 5B are front elevational views of representative commercially available high-speed printers which may be used in the system and method of FIG. 1.

### BRIEF DESCRIPTION OF THE PREFERRED EMBODIMENTS

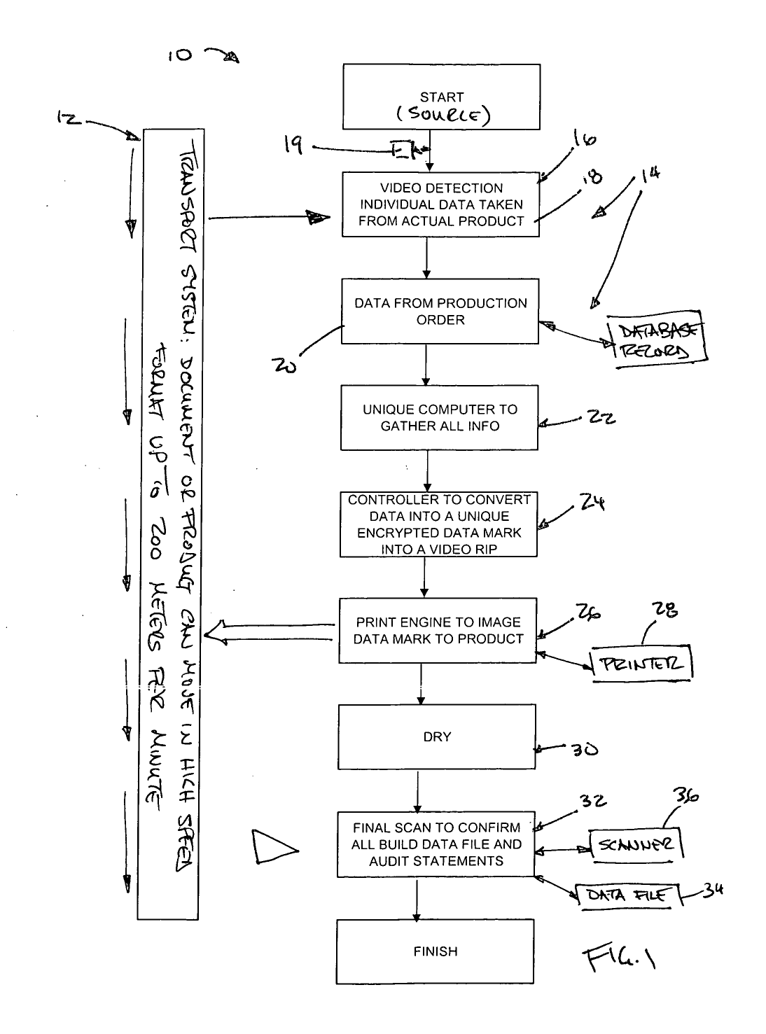

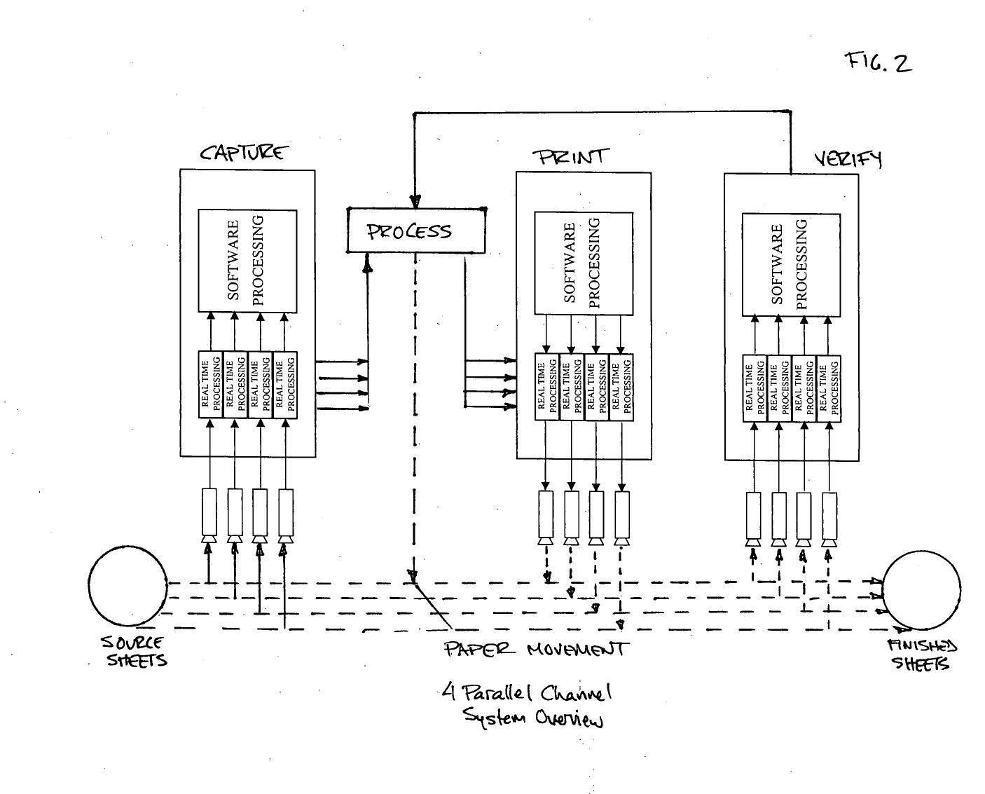

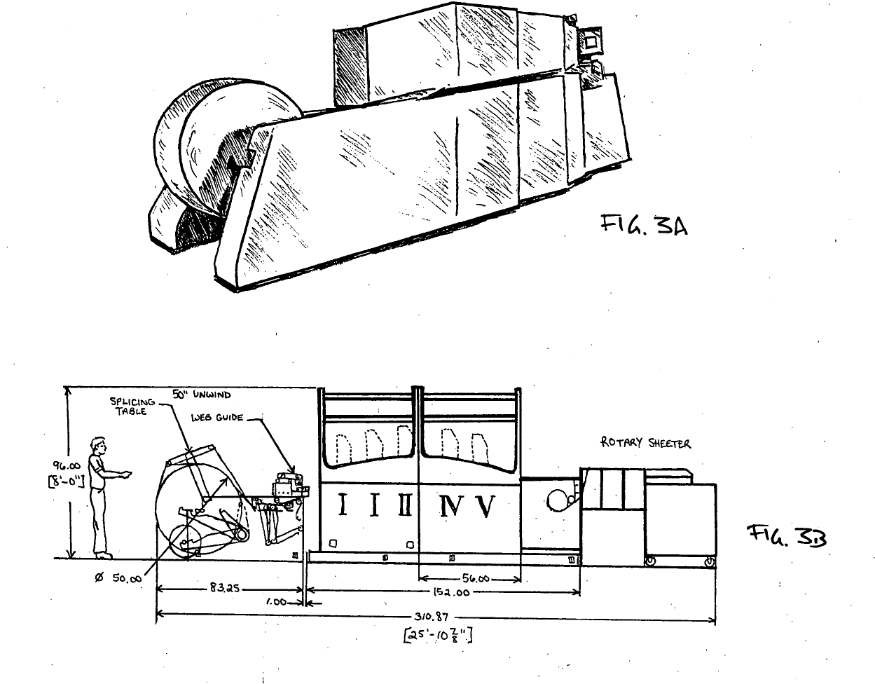

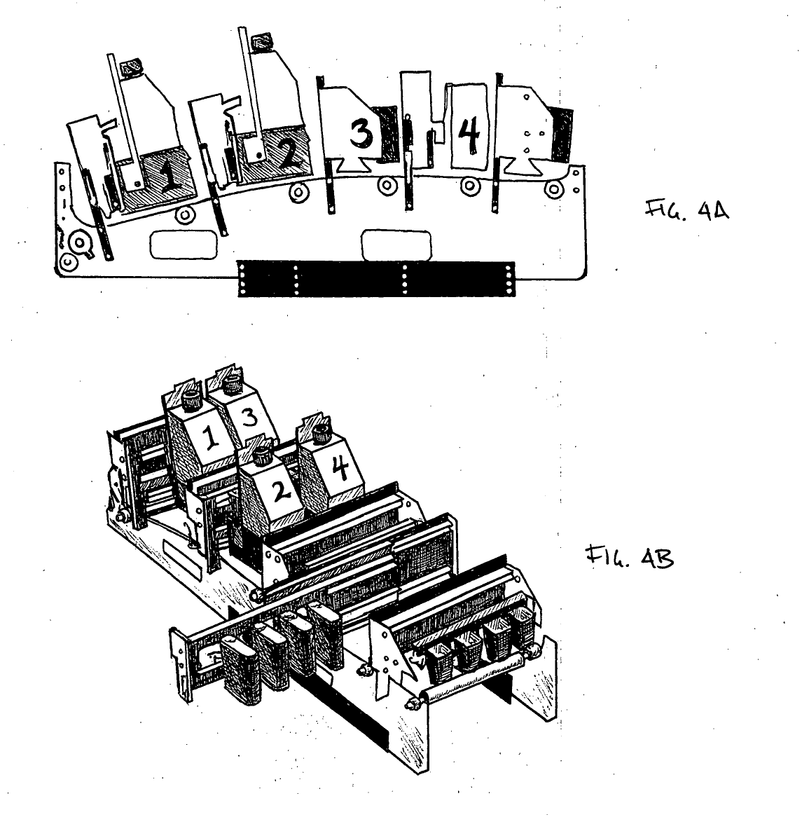

Referring to the drawings and, in particular, to FIG. 1 thereof, the system and method for the real time auditing of covert data marks of the present invention is provided and is referred to generally by reference numeral 10. The system 10 includes a transport system 12 designed to receive the product or document upon which the covert or invisible data mark is to be placed and transported at high speed through the detection, printing and scanning functions of the present invention. The transport system 12 may be either continuous, sheet or item, and may either be a stand alone or drop inline system depending on the requirement. For example, for coupons, tickets or stamp production, a single, continuous, sheet document may be used.

The various components 14 of the system 10 of the present invention are mounted or installed along the length of the transport system 12. The first component 12 is the video detection component 16, which comprises a video inspection system 18 design for inspection, confirmation, matching, and independent internal file building. The video inspection system 18 is normally of the type that works on a stand alone basis, and may indeed do so independently from the other components 14. In the preferred embodiment, the video inspection system 18 can check different and independent areas on the same or different products or documents at the same time.

The video inspection system 18 independently compares data or details for quality issues, confirms the data are correct and in proper sequence to subsequent numbers in relationship to the first, and even matches where there are more than one number or data field that should be the same. The video inspection system 18 further includes a management reporting system to record any flaws or defects in the characteristics of the identification data checked.

Depending upon the particular application, there may be as many as twelve (12) devices inspecting as many as thirty-six (36) numbers or items at the same time within one video inspection system 18. Furthermore, if more than one video system 18 is needed, any number of video inspection systems 18 can be piggy backed together. Depending upon the hardware utilized, the video inspection system 18 can be used to confirm, validate, verify and even authenticate. It is not date, number or language sensitive, and can used to inspect for any number regardless of the style (OCR, MICR, Gothic, Roman numeral, or number in various languages like Arabic). In the preferred embodiment, the video system 18 can search for several issues in real-time, and can be used for check the quality and sequence of nearly any bar code (Code 39, !2/5, UPC, Code 49, Code 16K, etc.)

In the preferred embodiment, the video detection component 16 comprises a unique high speed and high quality video detection system 18 which will capture specific data from the existing product or document. This identification data (ID) is typically provided on the product or document as existing eye-readable unique data in a number of different codes, including numeric, alpha, bar code(s), OCR, MICR, 2-dimensional bar codes, etc. A possible source for the video detection component 16 is Axode Corporation, located in Chicago, Ill.

The video detection component 16 is activated by an electronic signal from a proximity switch 19 or 360 degrees exact position. This signal will provide an exact location of the product or the document so that the aperture in the video inspection system 18 will know specifically when to capture the portion of the unique product or document to be used in the identification thereof.

Once this captured data is inspected and confirmed by the video inspection system 18, the information is forward in real-time to the next component 15 in the system 10—a computer database 20—with information for the production run.

Prepared information and specific details/information on the product is entered and stored in the computer database 20, which information will later be incorporated in the unique encrypted 2-dimensional data bar code. The database 20 may be specifically designed for each particular application to assist in the inventory control, distribution, authentication, verification and validation processes. For example, unique information such as inventory control number, production details, date sensitive data, even product or document information may be used.

It is often the case that the product or document includes individual and independent information (serial number, bar code number, UPC, denomination or value, etc) which can be taken directly from the product or document with the inline video system 18. This unique information is taken in real time and the database entry for that particular product is automatically completed by the computer database 20. It is this information and data which is converted into an encrypted 2-dimensional data bar code.

A unique process computer 22 is provided for gathering all the information required to create the 2-dimensional data marks, whether visible or invisible as required. This information may include biometrics which can be stored in the unique data mark. Examples of biometric information that may be incorporated include finger prints, hand or palm prints (slap), facial recognition (which can be stored with unique durable invisible ink either as an image or encrypted), biometric facial point or references for recognition, signature for comparison or matching, or iris scans.

The information for the data mark stored in the computer database 20 is converted into a “video rip” by printing controller 24. This video rip is the image that will be printed directly to the product or document. In the preferred embodiment, the process computer 22 and controller 24 are interfaced and exchange information back and forth as required by the system 10. The process computer 22 will take in the information from the database 20 as well as the new data from the video system 18 and combines the independent information or data for each product or document to be protected by the invisible encrypted data mark.

The process computer 22 will also take the added biometrics details if these options are selected by the client. This information could also be added to the particular record on the computer database 20.

In the preferred embodiment, the process computer 22 and controller 24 are incorporated in a unique newly designed and developed computer with controller capabilities. ID information is received from the video inspection system 18, preferably in real time by means of one or more parallel port, and merged into a database record, thereby forming the computer database 20. All text can be written in different languages and language symbols. The database record identification material is compiled by the process computer 22. This data may be encrypted at any level of security required by the particular product or document.

The database record is then converted by the controller 24 into a 2-dimensional data code or standard linear bar code. Either standard (16k, code 49, coda bar, ECC-200 (Mil Std 130), or even a stronger more unique code) may be used in such encoding. Unique software allows the system 10 to control the data and later confirm the actual imaged identification data, matching the information stored in the database record in the database 20.

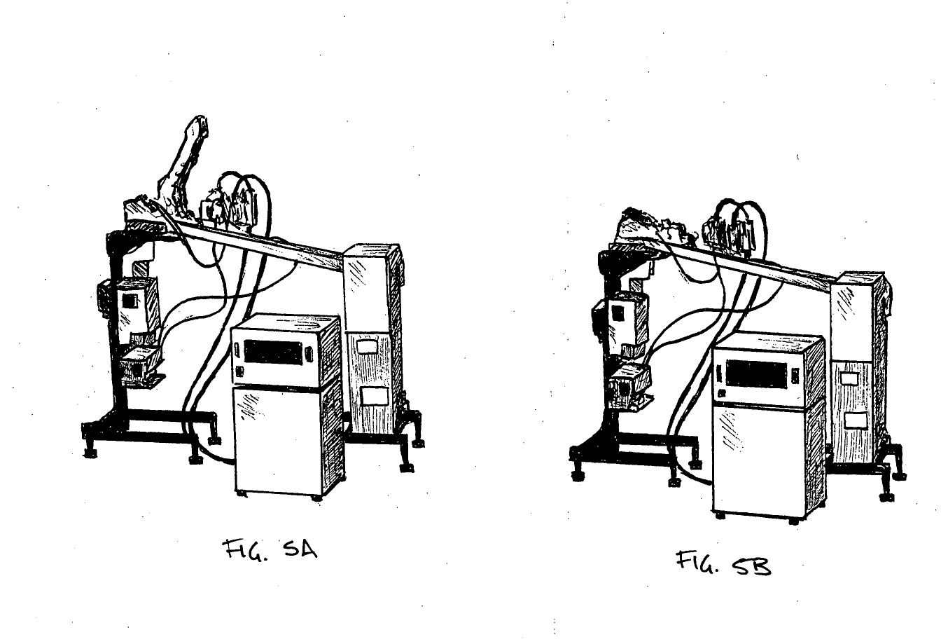

The video rip is sent by the print controller 24 to a print image engine 26. In the preferred embodiment, the print image engine 26 includes a high resolution, continuous, multi-nozzle print engine, 240 dpi×240 dpi inkjet printer 28, although the particular printer may be varied depending upon the particular product or document upon which the image is to be imprinted. FIGS. 5A and 5B illustrate some of the various types of printers 28, in this case laser printers, that may be used to bond the image directly to the product or valued document.

The print engine 26 may in some cases use unique black or colored ink to print eye-readable symbology. However, the security is increased dramatically by using non-commercial invisible inks, which inks prevent alteration or replication. These inks provide further security with many unique identification markers which make the ink impossible to duplicate. Without the exact chemical structure of the ink, the high-level encrypted 2-dimensional bar code cannot be found, much less identified and copied. These unique inks are also coupled with unique bonding agents to allow the encrypted invisible 2-dimensional bar code to all surfaces (paper, metal, plastic, rubber, etc.). The high speed inkjet imaging systems from Kodak in Dayton, Ohio, particularly the Kodak Versamark Inkjet Systems, 1″ Model 5240 4″ Model 6240 (240 dpi), is particularly effective for this application.

The covert data mark image is secured to the product or the valued document by activating bonding agents in the ink by drying the image in a dryer 30. The type of dryer 30 or drying process used is determined by the substrate the 2-dimensional data bar code mark is printed to. The drying takes place as the product or document continues to be moved along the transport system 12. The drying system 30 is preferably an off-the shelf drying scheme, depending on the bonding agents and the substrate. A number of different techniques are contemplated, such as heat, hot air, UV dryers, drying cylinder, festoon the web, etc., although any other method for drying ink may be utilized.

The final printed unique data mark is then scanned and decoded by a final scanning system 32. The decoded data is compared by the scanning system 32 to the original details/information incorporated into the database 20 to ensure consistency therewith. The final scanned original details/information may be considered an audit, which may be used to build a final finished data file 34 which, in turn, may be provided to the operator. This audit by the final scanning system 32 could also provide the final count for the number of data marks printed for a system 10 in which such marks were downloaded through a secured internet net work or phone line. At the same time the data file can be downloaded or burned to CD and an invoice can be simultaneously forward with the data file(s) to the client or agency.

This final scan is the most important step in the present system 10 since each unique invisible encrypted 2-dimensional bar code will then be read with the actual scanning device 36 which will be used in the field. This will guarantee the highest first read rate as each 2-dimensional bar code is scanned in the field. The scanner 36 is not commercially available and was developed specifically for this application. It may be used to read, decode, and move data in real-time or collect data to be downloaded later. Upon reading (at production speed), the scanner 36 will read and decode the total encrypted information stored in the data mark. This information is critical for product and document security, distribution, authentication, validation and verification. This final data base may also be used as an auditing trail as well as an accurate count of the number of data marks to be invoiced to the client or agency.

It should be appreciated that the same technology used for the scanner 36 during the process described herein will be used for the in-field scanner 36 for data decoding, matching, authentication, verification and validation. The in-field optical scanner 36 is designed to detect, read and decode the unique 2-demensional bar code, displayed in real-time or as a collection device to be downloaded at a later time. This ensures the security of the system because the scanner 36 has the optical setting which will allow the scanner 36 to emit a unique wave length, in the near-IR or IR range to excite the invisible inks used to print the data marks. A laser within the scanner 36 emits a special wave length in nanometers, causing the ink to instantly fluoresce and return a different wave length back to the scanner 36. It is this response which is read and decoded, thereby allowing the matching, authentication and verification of the data which is stored in the invisible data mark.

The in-field scanning device 36 can be hand held or a fixture that can scan a number of different documents, products or ID cards from a fixed distance. In the preferred embodiment, the in-field scanning device 36 includes a rechargeable battery which allows the operator to use the scanner 36 independent of a direct power source. Also in the preferred embodiment, the scanner 36 includes a voice, infrared, wireless, satellite or telephone connection, such as RJ-11 thru RJ-14 connection for real-time connection, or can download the items held in memory. The device 36 is designed to transmit in real-time to a server or main frame. In additional, the scanners 36 act as a data collection terminal as this information can be stored and download later via a number of different methods. The scanning device 36 can also be used as a simple authentication device to response when the unique ink is detected.

It should be appreciated that any number of different unique transport systems 12 may be provided for the required production scheme(s), the transport system 12 being designed around the requirement to carry the product or document. In the preferred embodiment, the transport system 12 utilized will be generally available or a modification of existing hardware or production equipment already in existence.

For example, unique transport systems 12 are already available for continuous production schemes like a paper web or roll (for U.S. postal money orders, continuous U.S. postal stamp production, money orders, travelers checks, business checks, lottery tickets, airline tickets, coupons, and other high value documents) where security features are inspected, data collected from the document itself, unique encryptions, imaged invisibly to the document, dried, final read and building a confirmed data file and each individual item can be tracked and traced from production (birth) to removal from service. An example of such a transport system 12 is Model 3700 available from Kodak Versamark Injet Systems in Dayton, Ohio.

For the payment card industry, another unique transport system 12 will be used so as to allow the individual payment cards to be stacked into a starting stack where they are fed one at a time to a high-speed conveyor. This conveyor will allow the covert data mark to be imprinted, then each card is read for the information and data to tie the card into the production scheme, then as the card moves on the conveyor, the computer/controller will take the important data and print it to each independent card, dried, final scan (while building a data file) and delivered for distribution to the banks or the card holders. An example of such a transport system 12 is available from Innovative Equipment Inc. located in Cortland Manor, N.Y.

In the pharmaceutical industry, the covert data mark will be mounted on the bottling or packaging production finishing line for the pharmaceutical. Here the video inspection system will read the individual data on the vial, bottle, plastic pack (which could be written text, eye readable visible bar code or OCR) as the product(s) moves on the conveyor, the computer/controller will take the important data and print it to each independent product(s) (vial, bottle, plastic pack), dried, final scan (while building a data file) and delivered for distribution, the invisible data mark will be scanned at all transaction points, to the point of dispensing.

For the parts marking industry, a hand held device may be provided to place the eye readable bar code or data (if required) directly to the part(s) upon manufacturing or for inventory control. The design of this device will depend on the parts to be marked. For example for Mil Std 130, the eye readable bar code would be ECC-200 compliant to match the requirements for the military parts inventory control, at the same time print an invisible unique data mark to elevate the level of security for each part and allow tracking as well as a trace back to the parts origin. Other industries where unique parts marking is important include jewelry, automotive, airplane, large or small machinery for inventory and warrantee protection, just to name a few.

Having thus described the invention with particular reference to the preferred forms thereof, it will be obvious that various changes and modifications can be made therein without departing from the spirit and scope of the present invention as defined by the appended claims.

Wherefore, I claim:

1. A system for printing data information marks on items for unique and independent identification, authentication and accountability, said system comprising means for invisibly imprinting said data information mark on said items using specially designed invisible inks and at least one scanning device designed to detect and read said invisibly imprinted mark.

2. A system for printing data information marks on items for unique and independent identification, authentication and accountability, said system comprising:
means for collecting information to be imprinted on said items;
means for converting said information into a unique encrypted data mark;
means for imprinting said encrypted data mark onto said items; and
means for confirming information contained on said encrypted data mark and creating an audit statement therefrom.

3. The system of claim 2, further including means for detecting and inspecting said items prior to said data mark being imprinted thereon.

4. The system of claim 3, wherein said means for detecting and inspecting comprises a video detection system.

5. The system of claim 2, wherein said means for collecting information comprises a computer database.

6. The system of claim 5, wherein said means for converting comprises a process computer to convert said information into said unique encrypted data mark.

7. The system of claim 6, further including a printing controller for converting said encrypted data mark into a video rip.

8. The system of claim 2, wherein said means for imprinting comprises an inkjet printer.

9. The system of claim 8, wherein said inkjet printer uses specially designed invisible inks.

10. The system of claim 9, further including a drying system for drying said inks.

11. The system of claim 2, wherein said means for confirming comprises a final scanner adapted to read said encrypted data mark and create a finished data file with information contained therein.

12. The system of claim 2, wherein said means for imprinting comprises an inkjet printer using unique invisible inks and wherein said means for confirming comprises a final scanner adapted to detect and read said encrypted data mark imprinted with said invisible inks and create a finished data file with information contained therein.

13. The system of claim 12, further including hand-held scanners usable at remote locations, said scanners being adapted to detect and read said encrypted data mark imprinted with said invisible inks.

14. The system of claim 2, further including a high-speed transport system.

15. A system for printing data information marks on items for unique and independent identification, authentication and accountability, said system comprising:
a video detection system for detecting and inspecting said items;
a computer database for collecting information to be imprinted on said items;
a process computer for converting said information into a unique encrypted data mark;
a printing controller for converting said encrypted data mark into a video rip;
an inkjet printer for imprinting said video rip onto said items;
a drying system for drying said inks; and
a final scanner adapted to read said encrypted data mark for confirming information contained on said encrypted data mark and creating an audit statement therefrom.

16. The system of claim 15, wherein said inkjet printer uses specially designed invisible inks.

17. A method for printing data information marks on items for unique and independent identification, authentication and accountability, said method comprising the steps of:
detecting and inspecting said items;
collecting information to be imprinted on said items;
converting said information into a unique encrypted data mark;
converting said encrypted data mark into a video rip;
imprinting said video rip onto said items;
drying said inks;
reading said encrypted data mark on said items;
confirming information contained on said encrypted data mark; and
creating an audit statement therefrom.
